(19) United States
(12) Patent Application Publication
(10) Pub. No.: US 2012/0326993 A1
(43) Pub. Date: Dec. 27, 2012

(54) METHOD AND APPARATUS FOR PROVIDING CONTEXT SENSITIVE INTERACTIVE OVERLAYS FOR VIDEO

(76) Inventor: Jordan K. Weisman, Bellevue, WA (US)

(21) Appl. No.: 13/334,887

(22) Filed: Dec. 22, 2011

Related U.S. Application Data
(60) Provisional application No. 61/436,494, filed on Jan. 26, 2011.

(51) Int. Cl. G06F 3/041

(52) U.S. Cl. 345/173

(57) ABSTRACT

When children watch videos on a touch screen device, their instincts are to touch the screen while the video is being played and they are disappointed when nothing happens when they do. The present invention provides an interactive graphical overlay responsive to touch input or other sensors. The overlay and various parameters are specified by metadata and synchronized with the video playout so that the interactive graphical overlay is appropriate to the context in which it appears.

### CROSS REFERENCE TO RELATED APPLICATIONS

This application claims priority to U.S. provisional application No. 61/436,494 filed Jan. 26, 2011.

### FIELD OF THE INVENTION

The present invention relates generally to a system and method for providing interactive overlays for video presented on touch-screen devices. More particularly, the invention relates to a system and method for providing in a multimedia container video with metadata to signal supported interactions to take place in an overlay layer.

### STATEMENT REGARDING FEDERALLY SPONSORED RESEARCH OR DEVELOPMENT

Not Applicable

### REFERENCE TO COMPUTER PROGRAM LISTING APPENDICES

Not Applicable

### BACKGROUND OF THE INVENTION

When children watch videos on a touch screen device, their instincts are to touch the screen while the video is being played and they are disappointed when nothing happens when they do. Examples of such touch screen devices are a tablet computer (e.g., the iPad, by Apple, Inc. of Cupertino, Calif.), or a smartphone (e.g., the iPhone, also by Apple, or those based on the Android operating system by Google Inc., of Mountain View, Calif.), and those touch screen devices and the like will be referred to herein as a “touch screen device”.

### OBJECTS AND SUMMARY OF THE INVENTION

The present invention relates generally to a system and method for providing interactive overlays for video. More particularly, the invention relates to a system and method for providing in a multimedia container video with metadata to signal supported interactions to take place in an overlay layer.

The interactions and overlays may be customized and personalized for each child.

The invention makes use of multimedia comprising a video (generally with accompanying audio) and metadata that describes which interactions can occur during which portions of the video. The video and metadata may be packaged in a common multimedia container, e.g., MPEG4, which may be provided as a stream or may exist as a local or remote file.

The child may use a touch screen to interact, or in some cases the invention can employ a range of other input sensors available on the touch-screen device, such as a camera, microphone, keypad, joypad, accelerometers, compass, GPS, etc.

Tags are inserted into the metadata of an MP4 or similar video codec, which the “game” engine (application) reads to determine, sometimes in combination with data about the child stored in a remote database, which interactive overlay graphics are available during specific intervals of video content. Interactive overlay content can be further contextualized by allowing triggering of different animated graphics within a specific time segment and/or within a specific area of the screen and/or triggered via a specific input sensor.

The graphics that are generated by a child's touch can have the following behaviors:

A single type of animated graphic is generated per time segment and/or screen location, which then travels around and/or off the screen.

A single type of animated graphic is generated per time segment and/or screen location, which then fades out or dissipates in some similar manner from the screen.

A series of animated graphics, such as a series of numbers or letters of the alphabet, are generated based upon the length of the child's swipe, a skill level of the child, or prior experience of the child with a particular interaction. These animated graphics can then either fade out and/or travel.

The color of the animated graphic generated could be modified based upon the time segment and/or screen location.

The size of the animated graphic could be modified based upon the time segment and/or screen location.

The suggested interactions above and those described in detail below are by way of example, and not of limitation.

### BRIEF DESCRIPTION OF THE DRAWINGS

These and other aspects of the present invention will be apparent upon consideration of the following detailed description taken in conjunction with the accompanying drawings, in which like referenced characters refer to like parts throughout, and in which:

FIG. 1 is a block diagram of one embodiment of a touch screen device suitable for use with the present invention;

FIG. 2 is an illustration showing the overlay layer and video layer being composited for the display in response to a touch screen interaction;

FIG. 3 is an illustration of the user's view of the processing performed in FIG. 2;

FIG. 4 shows a different interaction being provided at a different point in the same video;

FIG. 5 shows the user's view of the processing performed in FIG. 4;

FIG. 6 shows an overlay interaction that can be customized to a child user's skill level;

FIG. 7 show a portion of a personalized video (i.e., a video comprising user generated content);

FIG. 8 is an overlay interaction further personalized for use with the personalized video;

FIG. 9 show an example of an overlay providing an interactive tool;

FIG. 10 is an example of the interactive tool being used;

FIG. 11 is one example of metadata able to call each of the interactive overlay programs examples above in conjunction with the example video; and,

FIG. 12 is a flowchart for one embodiment of a process for providing overlay interactions appropriate to the context of a background video.

While the invention will be described and disclosed in connection with certain preferred embodiments and procedures, it is not intended to limit the invention to those specific embodiments. Rather it is intended to cover all such alternative embodiments and modifications as fall within the spirit and scope of the invention.

### DETAILED DESCRIPTION OF THE INVENTION

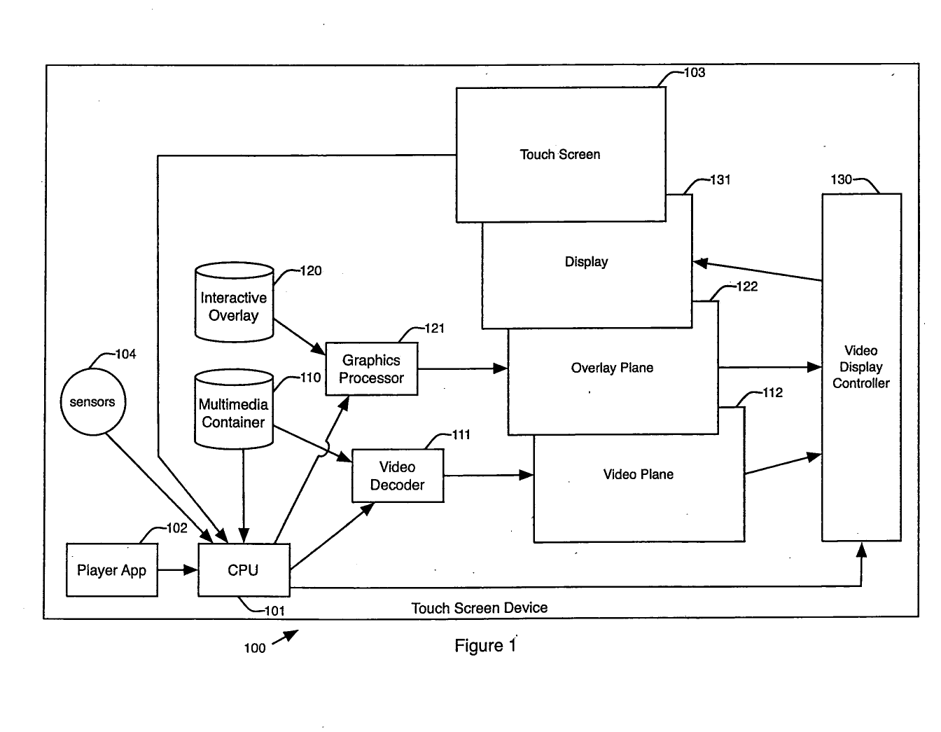

Referring to FIG. 1, one embodiment of a touch screen device 100 is shown, having CPU 101 able to run application 102 from memory and respond to input from touchscreen 103 and other sensors 104 (e.g., such as a camera, microphone, keypad, joypad, accelerometer, compass, GPS, etc.). Those skilled in the art will appreciate that the memory (not shown) for operating data and application 102, and the interfaces and drivers (not shown) for touchscreen 103 and sensors 104, all necessary for operation with CPU 101 are well known in the art.

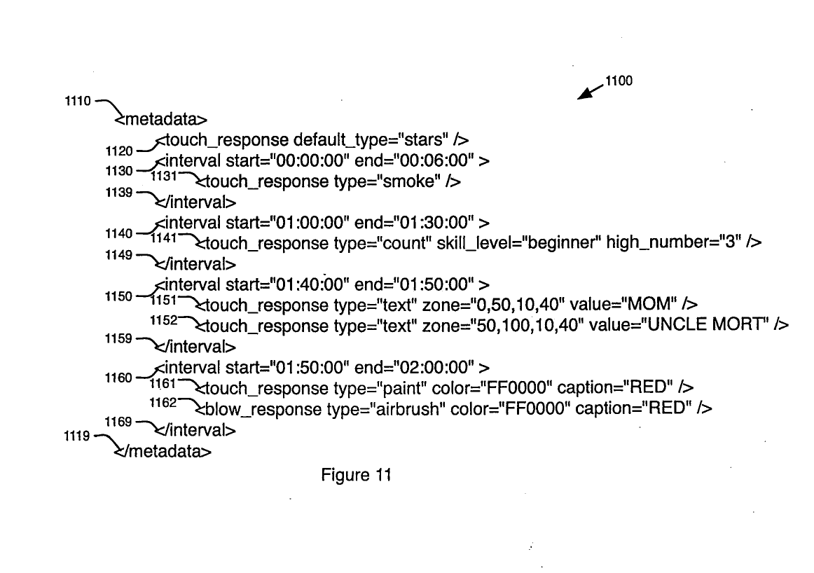

CPU 101, directed by player application 102, is provided with access to multimedia container 110 comprising the video to be played and the metadata for overlay interactions (one example embodiment described in greater detail in conjunction with FIG. 11). Multimedia container 110 may be a local file (as illustrated), a remote file (not shown), or a multimedia stream (not shown) as might be obtained from a server through the Internet.

For video to play, CPU 101 directs video decoder 111 to play the video from container 110. In response, video decoder 111 renders the video, frame by frame, into video plane 112. CPU 101 must also configure video display controller 130 to transfer each frame of video from the video plane 112 to the display 131.

For video to play with a graphic overlay, CPU 101 directs graphics processor 121 to an appropriate graphic overlay (e.g., an image, or graphic rendering display list, neither shown). For the present embodiment, the graphic overlay is an interactive overlay 120, known to application 102, and for which, through CPU 101, application 102 can issue interactive control instructions (e.g., by passing parameters in real time derived from input received from touchscreen 103 or sensor 104, or as a function of time, or both, thereby causing the overlay graphics to appear responsive to the input.

The output of the graphics processor is rendered into overlay plane 122. CPU 101 is further responsible for configuring video display controller 130 to composite the image data in overlay plane 122 with that in video plane 112 and present the composite image on display 131 for viewing by the user. Generally, the transparent touchscreen input device 103 physically overlays display 131, and the system is calibrated so that the positions of touch inputs on touchscreen 103 are correlated to known pixel positions in display 131.

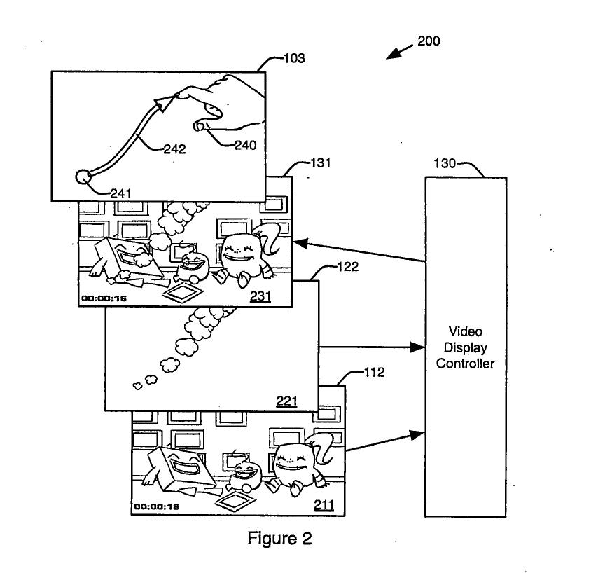

FIG. 2 illustrates a state 200 of touch screen device 100, and shows planes 112 and 122 in action, as an interactive overlay of the present invention is created. While frame 211 of video is being rendered by video decoder 111 into video plane 112 and presented on display 131 by video display controller 130, a finger of the user's hand 240 has touched down on touch screen 103 at location 241, and dragged across touch screen 103 along path 242. In reaction to this sequence of touches and to metadata describing how to respond at this point in the video, application 102 directs graphics processor 121 to execute a particular interactive overlay 120 and further provides graphics processor 121 with a series of parameters over time (corresponding to the incremental inputs from touch screen 103 regarding the touch down position 241 and path 242). In this example, graphics processor 121 renders frame 221 of smoke clouds into overlay plane 122 and CPU 101 instructs video display controller 130 to composite the smoke clouds frame 221 with a corresponding frame 211 of video, thereby producing image 231 on display 131 wherein the smoke clouds substantially appear to emit from location 241 and follow path 242 on display 131.

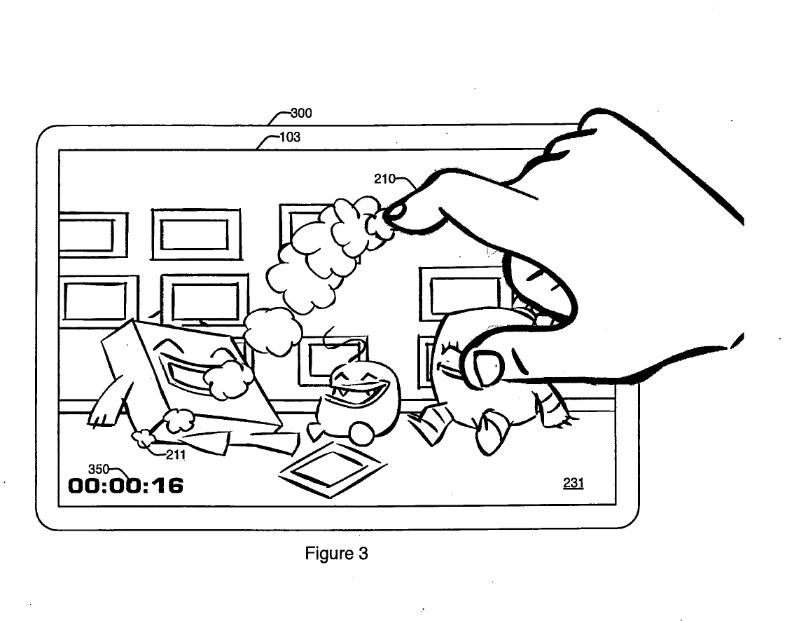

FIG. 3 shows the same interaction, but from the user's point of view, where touch screen device 300 shows composite image 231 on display 131 immediately and coincidentally underlying touch screen 103. The user's hand 210 having touched down on touchscreen 103 at location 211 has moved to its illustrated present position, and in its wake within image 231, a smoke contrail is left.

Timecode 350 in image 231 indicates where in the current video this scene is located, in a format MM:SS:FF representing a count of minutes, seconds, and frames from the beginning of this video. Timecode would not generally be appropriate for a child user, or most audiences. Timecode is more appropriate to video production personnel and system developers. However, for the purpose of explaining the present invention, timecode 350 is shown here because of a correspondence with the example metadata in FIG. 11.

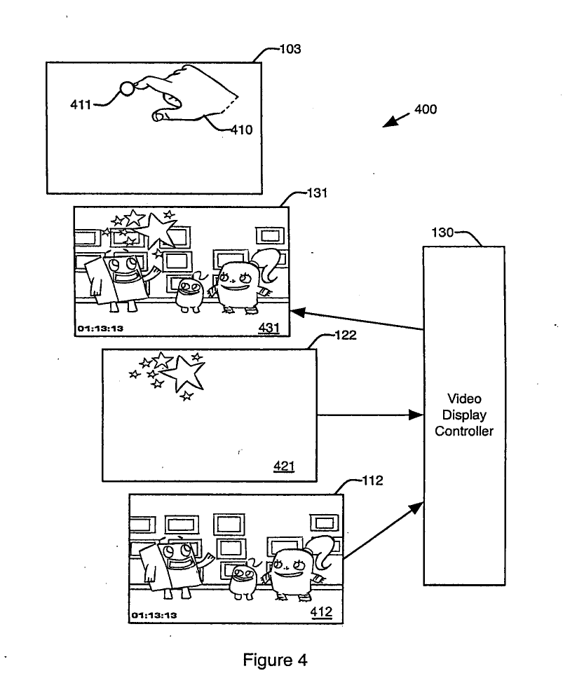

In a similar interaction illustrated in FIG. 4, a state 400 of touch screen device 100 shows video frame 412 in video plane 112, an overlay image 421 comprising stars in overlay plane 122, and a composite image 431 on display 131. Overlay image 421 was produced by graphics processor 121 in response to instructions issued through CPU 101 by application 102 initiated by a touch event at location 411 by user's hand 410 on touch screen 103. However, in this case, a default interaction (the stars) is used, as no more customized or personalized interactive overlay was prescribed by the metadata (see discussion with FIG. 11).

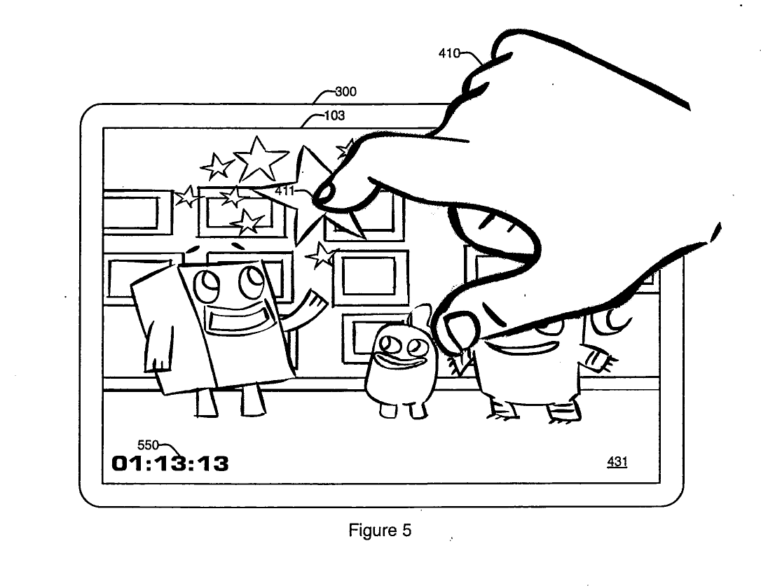

Again, FIG. 5 show the user's view of the interaction created in FIG. 4: On touch screen device 300, composite image 431 is presented, comprising the video currently playing at timecode 550, and the interactive overlay graphics displayed in response to the touch of user's hand 410 at location 411 on touch screen 103. However, as will be seen in conjunction with FIG. 11, the stars overlay animation playing at location 411 on display 131 is a default behavior described for the video for intervals when no more specific overlay has been prescribed in the metadata.

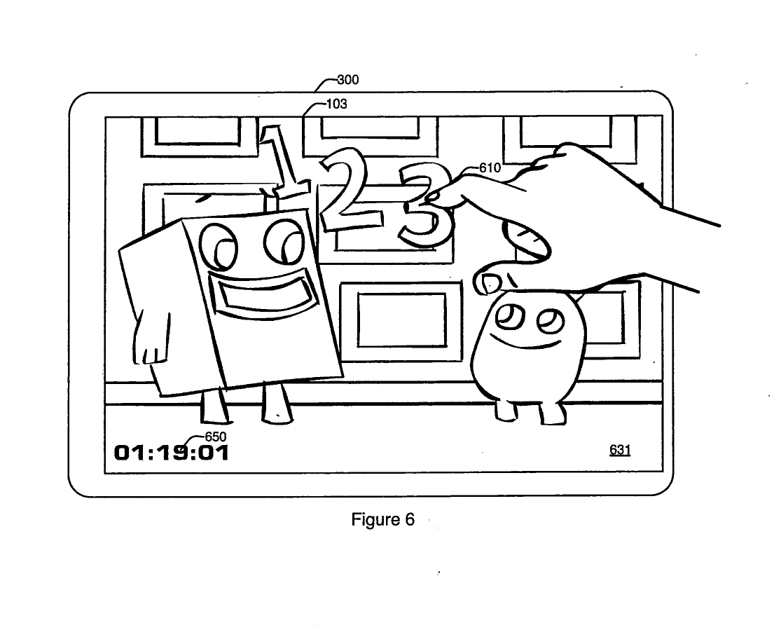

FIG. 6 shows an example of a customized overlay, that is, one that has been modified based on a score or rating or other data appropriate to the current user, but which may also be appropriate to many other users. In this example, the user is a child learning to count. Further, the child in this example is at an early stage in developing this skill. Thus, when a touch is prescribed by the metadata to provide a counting-related overlay (i.e., the number “1” at the touch down location and further numbers along the track of the touch's path), the size, scale, and frequency of the numbers might be varied according to a current assessment of the child's skill level. For instance, at timecode 650, composite image 631 exhibits a response to the recent touches by child's hand 610, namely that the numbers 1, 2, and 3 have been overlayed onto the background video. A rating of the child's counting skills was interpreted by application 102 to limit the overlay to a modest count at a modest counting rate. At higher levels of skill, the count might progress very rapidly with numbers streaming many-per-second from the current touch point, or counting may be by threes (e.g., 3, 6, 9) or some other increment value or more complex progression.

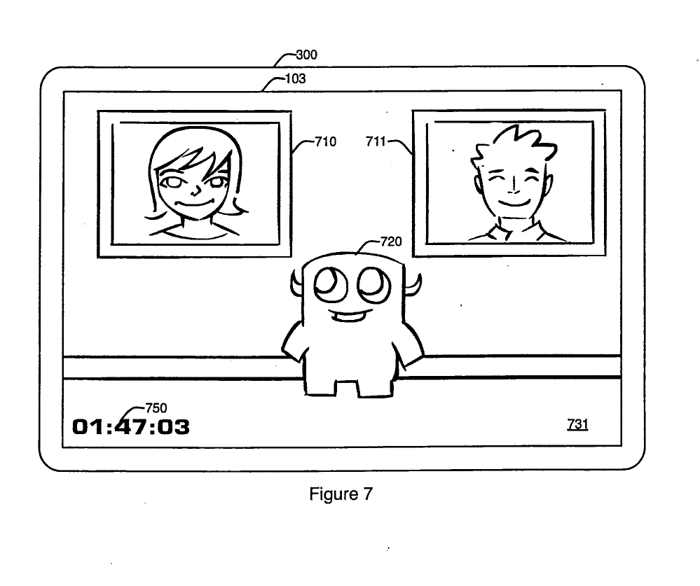

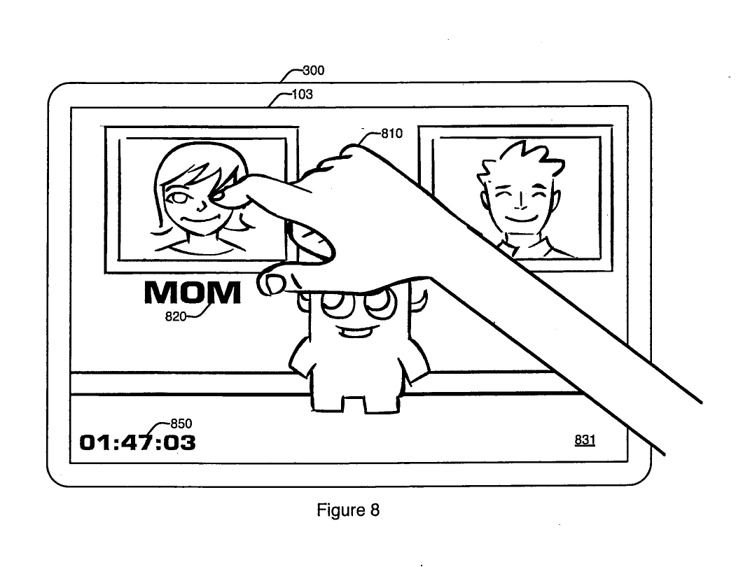

FIG. 7. Shows an example of a personalized presentation, wherein video frame 731 comprises two photographs or portraits 710 and 711 of the child's mother and father, respectively, and a character 720 which may have been selected as a favorite of the child. In this presentation, the corresponding metadata is also personalized, such that in FIG. 8, when the child's hand 810 touches one of the two photographs, in the illustrated case the photograph 710 of the child's mother, the name or caption 820 of that person “MOM” (or at least, the child's moniker for that person) appears. Note that the timecode 850 in image 831 is the same as timecode 750 in image 731 of FIG. 7. Thus, image 731 is what the presentation looks like if the video plays through timecode 750 without a touch, and image 831 is what the presentation looks like if the video plays through timecode 850, but a particular touch (i.e., one substantially on the photograph 710 of the mother) has occurred.

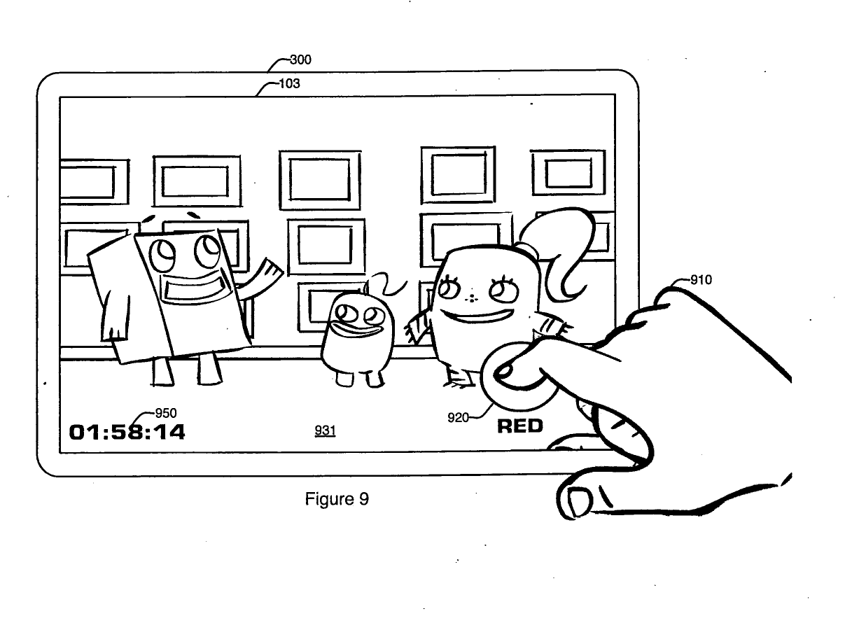

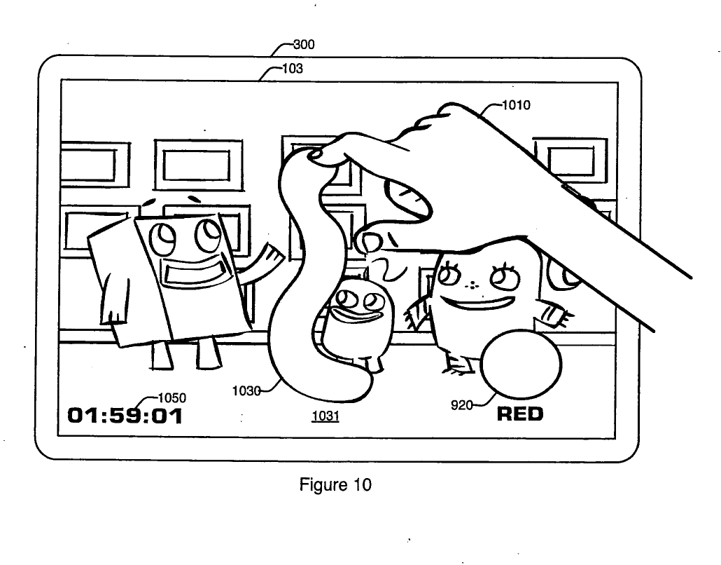

In FIG. 9, image 931 at timecode 950 shows a graphic overlay of a tool 920, which in this example indicates to the child that finger painting is available. By tapping the tool 920 with hand 910, the finger painting interaction is activated. Subsequently, in FIG. 10, at timecode 1050, composite image 1031 shows finger-painted red doodle 1030 draw by the path of the fingertip of child's hand 1010 on touch screen 103 since tool 920 was touched at timecode 950.

For the video shown in the examples above, there was corresponding metadata that defined which interactive graphic overlays were appropriate to which intervals within the video. FIG. 11 shows one embodiment of such metadata 1100, in this case as XML data identified by tag 1110, which starts the metadata, and tag 1119 that ends it.

Metadata 1100 includes default touch response tag 1120, which specifies the stars interaction shown in FIGS. 4 and 5. The rest of metadata 1100 in this example identify four distinct intervals each indicated by a respective one of start and end tag pairs 1130/1139, 1140/1149, 1150/1159, and 1160/1169. Each interval start tag contains two attributes, “start” and “end”, whose values are the timecodes in the corresponding video that bracket the interval (in this embodiment, the start and end timecodes are inclusive).

Between the start and end tag pairs defining each interval element, there are one or more overlay interaction elements, defined by tags 1131, 1141, 1151, 1152, 1161, and 1162.

Overlay interaction element 1131 (shown as a “touch_response” tag) specifies the smoke response of FIGS. 2 and 3 for any touch during the interval of video defined between the timecodes from the “start” and “end” attributes of interval tag 1130.

Overlay interaction element 1141 is responsible for the counting interaction shown in FIG. 6. As previously mentioned, customizations to the interaction, such as ones based on a child's skill level and/or highest learned number, may be provided by customized attribute values, as shown here. In an alternative embodiment, the child's skill level or other customized value may be provided by application 102, or may be retrieved from a database (not shown) of child skills and achievements.

In the interval element starting with tag 1150, there are two overlay interaction elements, 1151, and 1152. These correspond to each of the pictures used to personalize the video of FIGS. 7 and 8. The interaction is a simple one, a touch produces a certain text caption. The “zone” attribute defines a rectangular region of the display 131 (and correspondingly, a like region of touch screen 103). The values of the zone attribute are expressed as percentages, and in order are from-x, to-x, from-y, and to-y coordinates. That is, for tag 1151 which has zone=“0,50,10,40”, the rectangular zone runs horizontally from the left edge of display 131 (0%) to halfway across (50%), while running vertically 10% down from the top to 40% of the way down display 131: a rectangle that substantially encompasses the region of photograph 710 (and is a little generous on the sides). Likewise, photograph 711 is within the rectangular region defined by the zone of tag 1152: “50, 100, 10, 40” which has the same height as the other, but runs horizontally from the middle (50%) across to the right edge (100%) of display 131. For this interaction in this embodiment, when a touch occurs within a zone, the text in the value attribute is presented centered, immediately below the rectangle.

Thus, in FIG. 8, at timecode 850, which falls within the interval defined in interval element 1150, the touch of hand 810 falls within the bounds of the zone defined in tag 1151. In response, graphics processor 121 is directed to render the value attribute “MOM” as caption 820.

In this embodiment, as a design decision, the caption 820 remains until the interval expires or for three seconds, whichever is longer. Another design decision is how to handle subsequent touches that may trigger other overlay interactions within the same interval element, for example, tag 1152. An implementation may choose to allow only the first interaction triggered to operate for the duration of the interval, or the choice may be to allow a subsequent trigger to cancel the prior interaction and begin a new one, or an implementation may allow multiple interactions to proceed in parallel. In another embodiment, an alternative choice of units for zones might be used, e.g., display pixels or video source pixels.

In the interval element starting with tag 1160, there are two overlay interaction elements 1161 and 1162, of which touch_response tag 1161 is responsible for the finger-painting interaction in FIGS. 9 and 10. The first attribute for the paint interaction is the “color”, which becomes the parameter for graphics processor 121 to use for the tool 920 and the finger-painting (i.e., doodle 1030). In this embodiment, the color attribute uses an HTML-like hexadecimal color specification (in which “FF0000” translates to a red component of 255, and green and blue components of zero, thus producing a saturated red color). The caption attribute for the tool may be customized to the language the child is learning (which may or may not be the child's primary language), so “RED” might be replaced for other children with “ROT”, “ROUGE”, “ROJO”, etc.

Additionally, the final interval in metadata 1100 includes a non-touch based overlay interaction element in the form of “blow_response” tag 1162. This embodiment would employ a microphone, one of sensors 104, and respond to the volume of noise presented to that microphone by, for example, with graphics processor 121 simulating an airbrush or air stream blowing across tool 920, which behaves as wet red paint, producing a spatter of red paint in the overlay plane 122.

The programming and resources to respond to each overlay interaction element, whether touch_response tags, blow_response tags, or a response associated with other sensors, is stored as interactive overlay 120 and can be accessed and executed by graphics processor 121 as directed by and using parameters from application 102 running on CPU 101.

In an alternative embodiment, application 102 could perform the graphics rendering and write directly to overlay plane 122. In still another embodiment, application 102 could produce all or part of a display list to be provided to graphics processor 121 instead of using programs and resources stored as interactive overlay 120. Those familiar with the art will find many implementations are feasible for the present invention.

Metadata 1100 such as that contained in XML data may be presented all together, as if data were presented at the head of a multimedia file or start of a stream, or such metadata might be spread throughout a multimedia container, for example, as subtitles and captions often are. In some embodiments, the interactive overlay metadata could appear as a stream that becomes available as the video is being played, rather than all at once, as illustrated in FIG. 11.

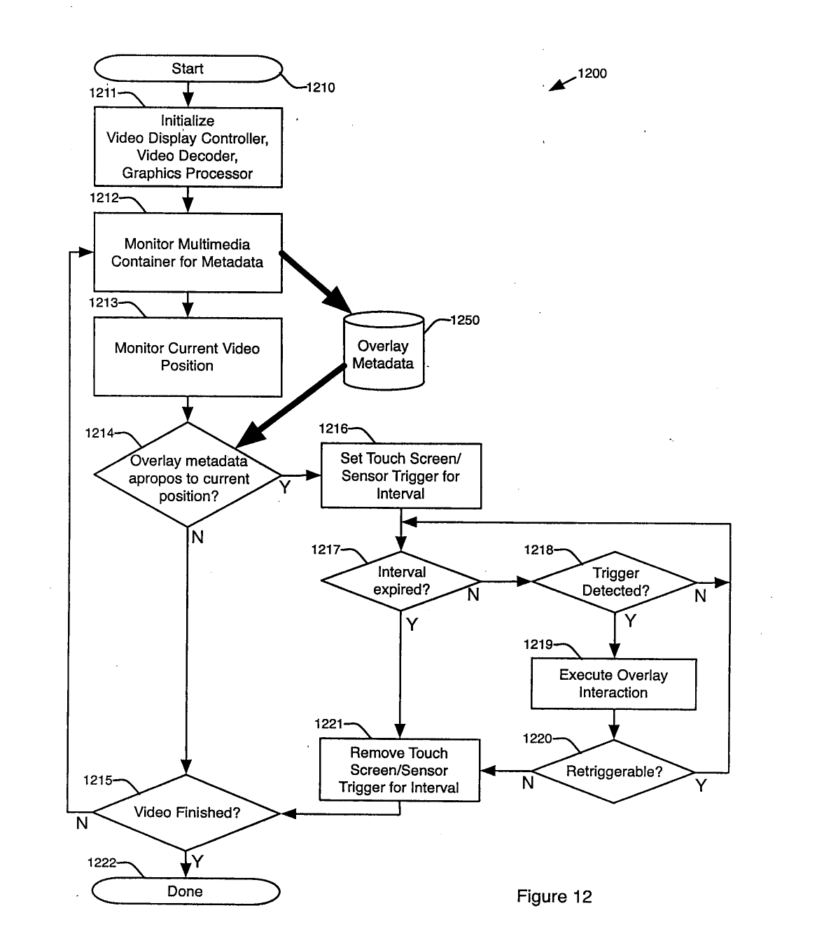

FIG. 12 is a flowchart for contextual overlay interaction process 1200, which starts at 1210 with overlay metadata cache 1250 clear, and the multimedia selection, including video, interactive overlay metadata, and any customizations or personalizations that are necessary already provided. Further, libraries of interactive overlays (e.g., 120) that may be referenced by the interactive overlay metadata are ready for use.

At 1211, the video display controller 130, video decoder 111, and graphics processor 121, are initialized and configured as appropriate for the video in container 110 and properties of display 131 (e.g., size in pixels, bit depth, etc., in case the media needs scaling). The video decoder is directed to the multimedia file or stream (e.g. container 110) and begins to decode each frame of video into video plane 112.

At 1212, container 110 (whether a file or stream) is monitored for the presence of interactive overlay metadata. If any interactive overlay metadata is found, it is placed in the overlay metadata cache 1250. If all metadata is present at the start of the presentation, then this operation need be performed only once. Otherwise, if the metadata is being streamed (e.g., in embodiments where the overlay metadata is provide like or as timed text for subtitles and captions), then as it appears it should be collected into the overlay metadata cache.

At 1213, the current position within the video being played is monitored. Generally, this comes from a current timecode as provided by video decoder 111. At 1214, a test is made to determine whether the current position in the video playout corresponds to any interval specified in overlay metadata cache 1250. If not, then a test is made at 1215 as to whether the video has finished playing. If not, interactive overlay process 1200 continues monitoring at 1212.

If, however, at 1214, the test finds that there is an interval specified in the collected metadata, then at 1216, an appropriate trigger is set for the corresponding sensor signal or touch region. Then, at 1217, while the interval has not expired (i.e., the video has neither ended nor advanced past the end of the interval), a test is made at 1218 as to whether an appropriate sensor signal or touch has tripped the trigger. If not, then processing continues to wait for the interval to expire at 1217 or a trigger to be detected at 1218.

When, at 1218, a trigger is found to have been tripped, then at 1219 the corresponding overlay interaction is executed, whether by CPU 101 or graphics processor 121 (or both). When the interaction concludes, a check is made at 1220 as to whether the interaction is retriggerable, (that is, allowed to be triggered again within the same interval), if so, the wait for another trigger or interval expiration resumes at 1217.

Otherwise, at 1220, when the interaction may not be triggered again during the current interval, the trigger is removed at 1221, which is the same action taken after the interval is found to have ended at 1217.

Following 1221, the test 1215 for the video having finished is repeated, with the process terminating at 1222 if the video is finished playing. Otherwise, the process continues for the remainder of the video by looping back to 1212.

As with all such systems, the particular features of the user interfaces and the performance of the processes, will depend on the architecture used to implement a system of the present invention, the operating system selected, whether media is local, or remote and streamed, and the software code written. It is not necessary to describe the details of such programming to permit a person of ordinary skill in the art to implement the processes described herein, and provide code and user interfaces suitable for executing the scope of the present invention. The details of the software design and programming necessary to implement the principles of the present invention are readily understood from the description herein. Various additional modifications of the described embodiments of the invention specifically illustrated and described herein will be apparent to those skilled in the art, particularly in light of the teachings of this invention. It is intended that the invention cover all modifications and embodiments, which fall within the spirit and scope of the invention. Thus, while preferred embodiments of the present invention have been disclosed, it will be appreciated that it is not limited thereto but may be otherwise embodied within the scope of the claims.

1. A machine-implemented method for context sensitive touch interaction on handheld device comprising the steps of:
a) providing a plurality of graphic overlays;
b) providing video with metadata, the metadata prescribing which of the plurality of graphic overlays is appropriate to each of at least one portion of the video;
c) presenting the video on a touch screen device;
d) detecting with the touch screen device, a user touch within a first portion of the video for which the metadata prescribes a first graphic overlay of the plurality of graphic overlays as appropriate;
e) responding with a processor to the metadata and the detected touch by causing a graphics processor to render and composite the first graphic overlay into the video presented on the touch screen device, with the first graphic overlay appearing in substantial coincidence with the user touch.

2. The method of claim 1 wherein the first portion of the video consists of a specific area of the screen.

3. The method of claim 2 wherein the specific area is rectangular.

4. The method of claim 1 wherein the first portion of the video consists of a specific time segment.

5. The method of claim 4 wherein the first portion of the video further consists of a specific area of the screen.

6. The method of claim 1 wherein the first graphic overlay is animated.

7. The method of claim 1 wherein the user touch is a tap and the first graphic overlay is composited at the location of the user touch.

8. The method of claim 1 wherein the user touch is a drag along a path and the first graphic overlay substantially follows the path.

9. The method of claim 1 wherein the metadata further prescribes a parameter for the first graphic overlay corresponding to the first portion of the video.

10. The method of claim 9 wherein the parameter is one selected from the group of color, text, and number to be used in rendering the first graphic overlay.

11. The method of claim 1 wherein the video with metadata is provided in a multimedia container.

12. The method of claim 11 wherein the multimedia container is MPEG4.

11. A memory, readable by the processor, containing the video with metadata for use in the method of claim 1.

12. A memory, readable by the processor, containing an application for performing the steps c), d), and e) of claim 1, the processor able to run the application to perform the method.
